(19) United States
(12) Patent Application Publication
(10) Pub. No.: US 2026/0326879 A1
(43) Pub. Date: Oct. 22, 2026

(54) PERMEABLE STRUCTURE FOR HIGH SPEED SWEPT SURFACES

(71) Applicant: General Electric Company, Evendale, OH (US)

(72) Inventors: Gregory Alexander Natsui, Halfmoon, NY (US); Nicholas Rathay, Rock City Falls, NY (US)

(21) Appl. No.: 19/653,936

(22) Filed: Apr. 21, 2026

Related U.S. Application Data
(60) Provisional application No. 63/791,940, filed on Apr. 21, 2025.

(51) Int. Cl. B64C 1/06; B64C 30/00

(52) U.S. Cl. CPC B64C 1/0683; B64C 30/00

(57) ABSTRACT

A vehicle having a component terminating at a tip. The tip being located at a stagnation point. The tip defining an axially forwardmost portion of the component with respect to the central axis. The outer wall includes an outer wall centerline, an inner surface, and an outer surface. The outer wall has a thickness between the inner surface and the outer surface. The component further has a porous material provided between the inner surface and the outer surface.

### CROSS-REFERENCE TO RELATED APPLICATION

This patent claims the benefit of U.S. Patent Application No. 63/791,940, which was filed on Apr. 21, 2025. U.S. Patent Application No. 63/791,940 is hereby incorporated herein by reference in its entirety. Priority to U.S. Patent Application No. 63/791,940 is hereby claimed.

### TECHNICAL FIELD

This disclosure generally relates to permeable structure for high-speed swept surfaces and, more specifically, to geometric features of portions of a vehicle, such as a nose section of a vehicle in which the nose section includes permeable structure.

### BACKGROUND

Some vehicles, for example aircraft, include a body extending between a nose and a tail, and at least two wings extending from the body. The aircraft can include one or more engines mounted to the wing or the fuselage to generate a thrust. During the operation of the aircraft, a streamlined airflow flows around the nose, over the wings, and ultimately past the tail. In some instances, the streamlined airflow at the nose can be compressed, causing a layer of air between the nose and the streamlined airflow to be heated. To counter this heating, aircraft can utilize a cooling circuit, specifically transpiration cooling, to cool the nose. Transpiration cooling is done by supplying a cooling fluid to an interior portion of the nose and exhausting the cooling fluid to an exterior portion of the nose through a porous material provided along the nose. The cooling fluid on the exterior of the nose then follows the streamlined airflow along the body, thus creating a film of cooling fluid over a portion of the body. This film of cooling fluid effectively insulates the nose and other parts of the body from thermal contact with the streamlined airflow.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of a vehicle, including a body extending between a nose section and a tail section, in accordance with the present disclosure;

FIG. 2 is a cross-sectional view of the nose section as taken along sectional line II-II of FIG. 1, in accordance with the present disclosure;

FIG. 3 is a graph illustrating local permeability (K_{local})/permeability at the tip (K₀) vs local heat flux (g_{local})/heat flux at the tip (q₀), in accordance with the present disclosure;

FIG. 4 is a graph illustrating local thickness (t_{local})/thickness at the tip (t₀) vs q_{local}/q₀, in accordance with the present disclosure;

FIG. 5 is a graph illustrating K_{local}/K₀ vs q_{local}/q₀ vs t_{local}/t₀, in accordance with the present disclosure; and

FIG. 6 is a graph illustrating K_{local}/K₀ vs t_{local}/t₀, in accordance with the present disclosure.

### DETAILED DESCRIPTION

Aspects of the disclosure herein are directed to a permeable structure for high speed swept surfaces, and more specifically to the geometry of a component of a vehicle.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something.

The component can include any suitable feature of a vehicle such as an aircraft, and can include, for example, a nose section, a portion of a wing, a fin-like control surface, and/or a vertical or horizontal stabilizer, a leading edge of an engine, a leading edge of a component within the engine, or any other suitable feature of the vehicle.

Although a nose section of an aircraft is used in this disclosure as an example component for purposes of brevity, it is contemplated that any transpiration-cooled component with a swept edge could be utilized. Indeed, the component is described herein in connection with a nose section of an aircraft which terminates at a tip and has an outer wall. The outer wall has a thickness that is flared moving from the tip in the aft direction. The flared area of the nose section can further include a porous material that enables a transfer of cooling fluid through the other wall of the nose section.

As used herein, the thickness or flared construction of the nose section will be referred to as the geometry of the nose section, while the inclusion of the porous material will be referred to as the composition of the nose section. The geometry and composition of the nose section provide increased efficiency when cooling the nose section through transpiration cooling.

For purposes of illustration, the present disclosure will be described with respect to a nose section of a supersonic vehicle or hypersonic vehicle. As used herein, the term “supersonic,” “supersonic aircraft” or variations thereof refers to an aircraft configured to fly at speeds at or exceeding the speed of sound (e.g., greater than or equal to Mach 1). As used herein, the term “hypersonic,” “hypersonic aircraft” or variations thereof refers to supersonic vehicles that travel substantially faster than the speed of sound, specifically greater than or equal to Mach 5. It will be understood, however, that aspects of the disclosure described herein are not so limited and can have general applicability within any suitable vehicle even though this disclosure is described herein with respect to a nose section in an aircraft. The features of the present disclosure can be used to provide benefits in industrial, commercial, and residential applications.

Additionally, as used herein, the terms “radial” or “radially” refer to a direction away from a common center. For example, in the overall context of an engine, radial refers to a direction along a ray extending between a center longitudinal axis of the engine (e.g., a turbine engine) and an outer engine circumference.

As used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure and do not create limitations, particularly as to the position, orientation, or use of aspects of the disclosure described herein.

Connection references (e.g., attached, coupled, secured, fastened, connected, and joined) are to be construed broadly and can include intermediate members between a collection of elements and relative movement between elements unless otherwise indicated. In this regard, connection references do not necessarily infer that two elements are directly connected and in fixed relation to one another. The exemplary drawings are for purposes of illustration only, and the dimensions, positions, order, and relative sizes reflected in the drawings attached hereto can vary.

In certain exemplary aspects of the present disclosure, a vehicle with a nose section is provided. During the operation of the vehicle, a streamlined airflow can flow against a portion of the nose section of the vehicle. The streamlined airflow flowing against the nose section can have kinetic energy. The kinetic energy is converted to internal energy in the form of heat and transferred to the nose section. The faster the vehicle goes, the higher the kinetic energy, and the higher the internal energy or heat that is transferred to the nose section. A vehicle that flies at supersonic speeds will experience larger heating of the nose section when compared to a vehicle that flies at subsonic speeds.

To counteract the heating of the nose section, the vehicle includes a cooling circuit that is used to feed a cooling fluid through a portion of the nose section to create a film of cooling fluid along the nose section. The film of cooling fluid insulates the nose section from the heat of the streamlined airflow. Hypersonic vehicles will experience even higher heating along the nose section when compared to a supersonic vehicle traveling at less than Mach 5.

A geometry and composition of the nose section is described below that is designed for higher speeds where the temperature of the compressed streamlined airflow is higher. The geometry and composition cools or insulates the nose section from the streamlined airflow. The geometry and composition can efficiently reduce the footprint and weight of the cooling circuit required to cool the nose section.

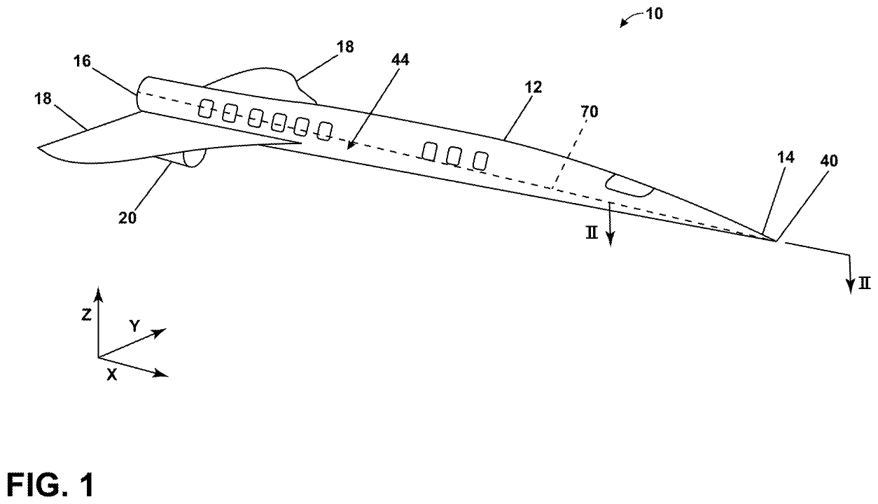

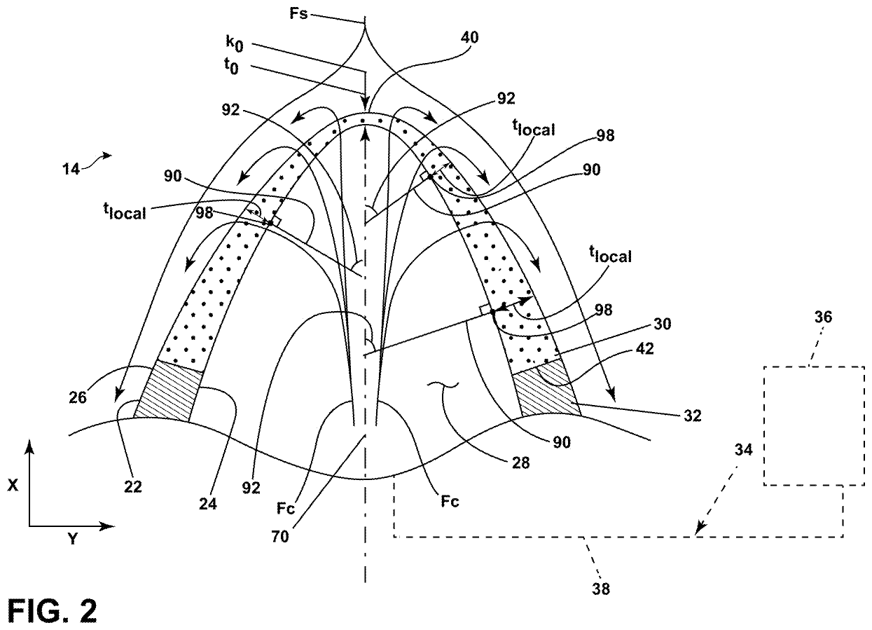

With reference to FIGS. 1 and 2, vehicle 10 can be any suitable vehicle such as, but not limited to, an aircraft. The vehicle 10 includes a body 12 having a center of gravity 44.

The body 12 of vehicle 10 includes a nose section 14 on a forward end and a tail section 16 on a rearward end. The nose section 14 terminates at a tip 40. The body 12 defines a central axis 70 that extends from the tip 40 of the nose section 14 to a rear end of the tail section 16. The tip 40 defines an axially forwardmost portion of the body 12 along the central axis 70 of the body 12. The central axis 70 can intersect or be offset from the center of gravity 44. The central axis 70 can be used to create an XYZ coordinate system where the x-axis is parallel to the central axis 70.

A set of wings 18 of vehicle 10 is coupled to the body 12 and extends radially outward from the body 12. The set of wings 18 can be formed as part of the body 12 (e.g., the body 12 can be shaped such that the body 12 defines the set of wings 18) or the set of wings 18 can form discrete bodies that connect to the body 12. There can be any number of wings in the set of wings 18 (e.g., one or more). The set of wings 18 can include one or more additional components not illustrated (e.g., ailerons, rudders, elevators, etc.) to move the vehicle 10 in any direction (e.g., roll, pitch, and/or yaw).

The vehicle 10 can further include a set of engines 20 with any number of engines. As illustrated, the set of engines 20 can be a set of one or more turbine engines; however, any suitable number or type of engine is contemplated. During operation of the vehicle 10, the set of engines 20 generates a thrust to propel the vehicle 10.

The cross-sectional view of FIG. 2 illustrates an example component, e.g., the nose section 14, as taken along sectional line II-II of FIG. 1. The nose section 14 includes an outer wall 22. The outer wall 22 includes an inner surface 24 and an outer surface 26. The outer surface 26 includes an exterior surface of the nose section 14. The outer wall 22 defines an outer wall centerline 96 equidistant between the inner surface 24 and the outer surface 26.

An interior cavity 28 of the nose section 14 can be at least partially defined by the inner surface 24 of the outer wall 22 and can be completely or partially hollow.

The nose section 14 or portions thereof can include a porous material 30. As used herein, the term “porous material” can refer to any material with a permeability high enough to enable fluids such as, but not limited to, air, CO₂, N₂, steam, liquid H₂O (or other liquids), lithium (or other liquid metals), a noble gas, or any combination thereof, to pass through the porous material 30. The porous material 30 can have any suitable porosity such as, but not limited to, greater than or equal to about 10% and less than or equal to about 50%. As a non-limiting example, the porous material 30 can be, but is not limited to, high-temperature metals, high-temperature ceramics, or a combination thereof. As a non-limiting example, high-temperature metals can include but are not limited to, refractory high entropy alloys, Ni-based superalloys, titanium zirconium molybdenum (TZM), niobium-hafnium-titanium or C103 niobium alloy (C103), or the like. As a non-limiting example, high-temperature ceramics can include, but are not limited to, carbon-carbon, ceramic matrix composite (CMC), ultra-high-temperature ceramics, or the like. The porous material 30 can be provided along any suitable portion of the outer wall 22.

The nose section 14 of vehicle 10 can further include a non-porous material 32. The non-porous material 32 can be any suitable material that does not enable a fluid, such as air, to pass therethrough. Conversely, the porous material 30 can be any suitable material that enables a fluid, such as air, to pass therethrough. The porous material 30 transitions to the non-porous material 32 at a transition portion 42. It will be appreciated that the porous material 30 can be continuously or non-continuously provided over an extent of the nose section 14. As a non-limiting example, the nose section 14 can include at least a portion of the non-porous material 32 within the illustrated portion of the porous material 30.

The outer wall 22 of the nose section 14 can include a set of localized positions 98 provided along the inner surface 24. Each localized position of the set of localized positions 98 is spaced axially along the inner surface 24 with respect to the outer wall centerline 96. A straight line 90, perpendicular to the inner surface 24, can be defined from a respective localized position of the set of localized positions 98 that intersects the central axis 70 at an angle 92, i.e., sweep angle (L). Under the nominal orientation of the vehicle (zero side sweep), the subscript 0 for the component is defined at a local stagnation point. The local stagnation point is a point in a fluid flow where the local fluid velocity is zero in all directions. Moving away from the local stagnation point, as the surface angle changes, the sweep angle changes accordingly. Sweep angle (L) can range from about 0 to about 90 degrees and preferably between about 0 degrees and about 60 degrees. Generally, the inventors have found that as the 60-degree sweep angle is exceeded, the need for transpiration decreases, and ejection would artificially thicken the body, which would be detrimental.

Each straight line 90 extends perpendicularly from the inner surface 24 where the localized position is provided along the inner surface 24. For purposes of illustration, three sweep angles 92 and three straight lines 90 are illustrated; however, it will be appreciated that there can be any number of sweep angles 92 (e.g., one or more) and accompanying straight lines 90. It is contemplated that the sweep angle 92 can be used to identify where the localized position is provided. For example, it is contemplated that all sweep angles 92 that are axially aft of the inner surface 24 at the tip 40 can be non-zero or otherwise include an absolute value that is greater than zero. In other words, the only sweep angle 92 that is zero is where the inner surface 24 is at the tip 40. It is contemplated that the sweep angles 92 can increase constantly or non-constantly axially from the tip 40 along the outer wall centerline 96.

The set of localized positions 98, defined by the sweep angle 92 and the straight line 90, are used to define locations along the outer wall 22 and the composition and geometry of the position. For example, each localized position 98 defines a location along the outer wall 22 having a respective thickness and a respective permeability. Permeability is a geometric property of a porous structure. The permeability of the porous structure can be detected by obtaining a cylindrical slug from the structure or based on optical measurements.

As a non-limiting example, the inner surface 24 at the tip 40 is a localized position 98 having a tip thickness (t₀) at the tip and a permeability (K₀) at the tip. The tip thickness (t₀) at the tip 40 is defined as the straight-line distance between the inner surface 24 at the tip 40 to the outer surface 26 at the tip 40, with the straight-line distance being parallel to the straight line 90 intersecting the localized position 98 of the inner surface 24 at the tip 40.

As used herein, subscript 0 refers to the value of a given parameter at the component stagnation point. If the component is the vehicle's (e.g., hypersonic or supersonic aircraft) leading edge, the stagnation point and subscript 0 reference is the nose tip of the vehicle. If the component is a fin-like control surface downstream, such as a vertical or horizontal stabilizer, then the upstream flow field can be slightly influenced and the stagnation point may not be immediately obvious (even for the vehicle, shuttle re-entry is an example of where the geometric tip may not be the design condition stagnation point). For example, the local region over the transpiring surface with minimum thickness is likely the assumed stagnation region.

As a non-limiting example, the outer wall 22 can include a local thickness (t_{local}) and a local permeability (K_{local}). The local thickness (t_{local}) and local permeability (K_{local}) are localized values determined for a particular location along the outer wall 22. The local thickness (t_{local}) is defined as the straight-line distance between the inner surface 24 at a respective localized position 98 to the outer surface 26, with the straight-line distance being parallel to the straight line 90 intersecting the respective localized position of the inner surface 24. The local thickness (t_{local}) is offset from the tip 40 along the outer wall centerline 96. The local thickness (t_{local}) can be detected by cross sectioning of the component or other optical measurements. The thickness (t₀) is a minimum thickness of the nose section 14, while the local thickness (t_{local}) is greater than the thickness (t₀). The local thickness (t_{local}) can gradually increase in size as the localized position of the local thickness (t_{local}) moves aft of or downstream from the tip 40 (the thickness (t₀)) along the outer wall centerline 96. The increase of the thickness along the outer wall centerline 96 aft of the tip 40 defines a flared cross-section of the outer wall 22.

The tip thickness (t₀) at the tip 40 can range from about 0.2 mm to about 35 mm (e.g., between about 0.5 mm and about 14 mm for even more improved balance between thickness and strength). The local thickness (t_{local}) can range from about 0.2 mm to about 35 mm (e.g., between about 0.5 mm and about 14 mm for even more improved balance between thickness and strength). The local thickness (t_{local}) can be at most about seven times the tip thickness (t₀) at the tip 40. Generally, the inventors found that the tip thickness (t₀) at the tip must be thick enough at the stagnation point to provide suitable strength for durability in flight.

The permeability (K₀) of the porous material at the tip 40 can range from about 0.08 um² to about 10 μm² (e.g., about 0.2 μm² to about 3 μm² for even more improved balance of pressure). The local permeability (K_{local}) of the porous material 30 can range from about 0.04 μm² to about 25 μm² (e.g., about 0.1 μm² to about 7.5 μm² for even more improved balance of pressure). Generally, the inventors found that if the permeability (K₀) of the porous material 30 at the tip 40 and/or the local permeability (K_{local}) of the porous material 30 was too low, excessive pressure is required to drive flow, and if the permeability (K₀) of the porous material at the tip and/or the local permeability (K_{local}) of the porous material was too high, the material would be too open and too small such that a pressure difference is needed.

The local thickness (t_{local}) linearly or non-linearly increases in size from the tip 40 along the outer wall centerline 96. It will be appreciated, however, that at least a portion of the outer wall 22 aft of the tip 40 can decrease in thickness to define features along the outer wall 22 such as, but not limited to, a bump, a depression, a divot, or a combination thereof. As a section of the nose section 14 can decrease in thickness, but the thickness of the nose section 14 still increases from the tip 40 to a rearmost position of the porous material 30, the nose section 14 can be said to generally increase in size from the thickness (t₀) to an axially rearward thickness of the plurality of local thicknesses (t_{local}) to define the flared cross-section.

It will be appreciated that the nose section 14 can be symmetric or non-symmetric about the central axis 70. As a non-limiting example, the porous material 30 can be symmetric or non-symmetric about the central axis 70.

The vehicle 10 can include a cooling circuit 34 having a cooling fluid source 36 and a fluid duct 38. The cooling fluid source 36 can be any suitable source of cooling fluid such as, but not limited to, a reservoir (e.g., a reservoir having a compressed cooling fluid such as water), the set of engines 20 (FIG. 1) as bleed air from a portion of the set of engines 20, or any combination thereof. The cooling fluid source 36 can be provided within any suitable portion of the vehicle 10. The fluid duct 38 is disposed in fluid communication with a portion of the nose section 14. As a non-limiting example, the fluid duct 38 is directly coupled to the interior cavity 28.

During operation of the vehicle 10, a streamlined airflow (Fs) flows against the nose section 14. The streamlined airflow (Fs) includes kinetic energy as streamlined airflow (Fs) flows against the nose section 14 that is a function of the speed of the vehicle 10. The kinetic energy of the streamlined airflow (Fs) is converted to an internal energy, which is transferred to the nose section 14 in the form of heat. The conversation of the kinetic energy of the streamlined airflow (Fs) to internal energy in the form of heat will be hereinafter referred to as the heating of the nose section 14. The heat transferred to the vehicle 10 is greatest at the tip 40 of the nose section 14. As the vehicle 10 moves faster, the streamlined airflow (Fs) includes more kinetic energy, and more heat is transferred to the nose section 14.

The cooling circuit 34 of the vehicle 10 can selectively supply cooling fluid (Fc) from the cooling fluid source 36 through the fluid duct 38 to the nose section 14. The cooling fluid (Fc) flows through the interior cavity 28 and impinges respective portions of the inner surface 24 of the outer wall 22. The cooling fluid (Fc) flows through the porous material 30 of the outer wall 22 and to the outer surface 26. Once on the outer surface 26, the cooling fluid (Fc) moves with the streamlined airflow (Fs) and creates a film of cooling fluid (Fc) between the streamlined airflow (Fs) and the outer surface 26 of the nose section 14. The film of cooling fluid (Fc) insulates the nose section 14 from the streamlined airflow (Fs), ensuring that the streamlined airflow (Fs) does not overheat the nose section 14. This movement of the cooling fluid (Fc) through the porous material 30 is a form of transpiration cooling.

More cooling is generally required as the vehicle 10 moves faster. In cases where the vehicle 10 is a supersonic vehicle traveling at supersonic speeds, the heat that is generated can cause damage to the vehicle 10. In cases where the vehicle 10 is a hypersonic vehicle traveling at hypersonic speeds, the heat that is generated at the nose section 14 is generally larger than the heat that is generated at the nose section 14 of supersonic vehicle traveling at supersonic speeds. The heat that is generated at the nose section 14 of subsonic vehicle is generally negligible and cooling may not be required.

The heating of the nose section 14 of a conventional vehicle can be characterized by a plurality of heat fluxes. Each section of the nose section 14 can be defined by a respective heat flux. The heat flux is defined as the predicted, measured, or otherwise anticipated flow of energy (e.g., heat) between the streamlined airflow (Fs) and a respective portion of the nose section 14. A heat flux (q₀) at the tip can be experienced at the tip 40 and a local heat flux (q_{local}) can be experienced aft of the tip. In some instances, the heat flux (q₀) at the tip or the local heat flux (g_{local}) can be high enough to cause damage to a respective portion of the component (e.g., nose section 14) of the conventional vehicle.

In the conventional vehicle (e.g., a vehicle without the flared nose section 14 or constant permeability), a thermal gradient is created between the tip 40 and a location offset from the tip 40, with the temperature at the tip 40 being the highest. An even distribution of cooling fluid does not fit the temperature gradient. The cooling fluid distribution can sufficiently cool the tip 40 but locations of the nose section 14 aft of the tip 40 will receive an amount of cooling fluid that is more than what is needed to sufficiently cool the nose section 14. The nose section 14 will be overly cooled and cooling fluid is wasted. An inefficient cooling system generally requires a cooling circuit with a larger footprint and that has more weight.

The cooling system of FIG. 2 efficiently distributes a cooling fluid to the nose section 14 because of at least one of the geometry or composition of the nose section 14. At least one of the geometry or composition of the nose section 14 can be determined according to the calculated, measured, or modeled nose heat flux (q₀) and the local heat flux (g_{local}).

Table 1 below illustrates some configurations developed by the inventors that provided novel, improved solutions to the cooling problem, where K₀ and to are measured at the tip and K, t, and L are measured at localized points on the structure as shown in the example of FIG. 2.

TABLE 1

| K₀ | K | t₀ | t | L |
|---|---|---|---|---|
| μm² | μm² | mm | mm | degrees |
| 1 | 1 | 1 | 1 | 0 |
| 1 | 1 | 1 | 1.006171 | 10 |
| 1 | 1 | 1 | 1.06188 | 30 |
| 1 | 1 | 1 | 1.122163 | 40 |
| 1 | 1 | 1 | 1.4 | 60 |
| 1 | 1 | 1 | 1.769522 | 70 |
| 1 | 1 | 1 | 1 | 0 |
| 1 | 0.993867 | 1 | 1 | 10 |
| 1 | 0.941726 | 1 | 1 | 30 |
| 1 | 0.818137 | 1 | 1 | 50 |
| 1 | 0.565124 | 1 | 1 | 70 |
| 1 | 1 | 1 | 1 | 0 |
| 1 | 1 | 1 | 1.061706 | 10 |
| 1 | 1 | 1 | 1.618802 | 30 |
| 1 | 1 | 1 | 3.222895 | 50 |
| 1 | 1 | 1 | 8.695218 | 70 |
| 1 | 1 | 1 | 1 | 0 |
| 1 | 0.94188 | 1 | 1 | 10 |
| 1 | 0.617741 | 1 | 1 | 30 |
| 1 | 0.31028 | 1 | 1 | 50 |
| 1 | 0.115006 | 1 | 1 | 70 |

The inventors determined that the geometry of the component (e.g., the tip thickness (t₀) and the local thickness (t_{local}) for nose section 14) and/or the composition of the component (e.g., the permeability (K₀) at the tip 40 and the local permeability (K_{local}) of the porous material 30) can be varied to efficiently cool the nose section 14. A cooling circuit 34 with less weight and a smaller footprint can be used with the improved geometry and/or composition of the nose section 14.

The designs developed by the inventors can be characterized by a ratio between the heat flux (q₀) at the tip 40 and the local heat flux (g_{local}) determined with respect to a ratio between a) the ratio between tip thickness (t₀) and the local thicknesses (t_{local}) and b) the ratio between the permeability (K₀) at the tip and the local permeability (K_{local}), reflected in the following expression:

$$\frac{{q}_{local}}{{q}_{0}} = \frac{( \frac{{k}_{local}}{{k}_{0}} )}{( \frac{{t}_{local}}{{t}_{0}} )} . \qquad ( 1 )$$

A heat flux parameter (c) can be formed from expression (1). The heat flux parameter (c) reflects the inventors' inventive designs and tracks the variability of incident heat flux (e.g., between local heat flux (g_{local}) and heat flux at the tip (q₀)). For values of heat flux parameter (c) on the lower end of the range, less variation in the incident heat flux can be expected. The heat flux parameter (c) is determined with respect to a ratio between a) the ratio between tip thickness (t₀) and the local thicknesses (t_{local}) and b) the ratio between the permeability (K₀) at the tip and the local permeability (K_{local}) over the secant of the sweep angle (L)−1 according to the following expression:

$$c = \frac{( {t}_{local} / {t}_{0} ) / ( {K}_{local} / {K}_{0} )}{sec ( L ) - 1} , \qquad ( 2 )$$

wherein c is between 0.4 and 4.0.

The expressions (1) and (2) can be used to characterize the set of designs developed by the inventors, reflecting how the permeability or thickness of the nose section 14 changes with or is otherwise dependent on the other of the permeability or thickness of the nose section 14 as well as the sweep angle (L) 92. The set of inventive designs created by the inventors and identified using expression (1) enable transpiration cooling at swept leading edges of the hypersonic vehicle (e.g., leading edge of the nose section, a portion of a wing, a fin-like control surface, and/or a vertical or horizontal stabilizer of the hypersonic vehicle) using porous media with variable resistance, which is created by adjusting wall thickness and/or permeability of the material. The heat flux parameter (c) is a shorthand to represent inventive designs that provide locally-prescribed flow resistance that improves cooling while balancing durability and structural integrity.

Advantageously, the inventors determined that the selection of the geometry and composition of the nose section 14, as reflected in expressions (1) and (2), improves the mass flow rate of the cooling fluid (Fc) to specific locations of the nose section 14, such that the locations of the nose section 14 do not receive too much or too little cooling fluid (Fc).

The inventors further determined that tailoring the geometry and composition of the nose section 14 such that the permeability of the material forming the nose section 14 decreases while the thickness of the material increases from the tip 40 to aft of the tip 40 (e.g., the flare), which causes a highest amount of cooling fluid (Fc) being fed to the tip 40, where the heating of the nose section 14 is largest, and a lowest amount of cooling (Fc) being fed to the aft portions of the nose section 14 where the heating is lowest, as reflected in expressions (1) and (2).

These designs developed by the inventors provide improvements to thermal management of high-speed vehicles. Specifically, designing a component as reflected in relationship (2) aims to reduce coolant flow consumption, which is a barrier to entry for external cooling approaches. The disclosed technology provides the benefit of directly addressing the minimization of the burden of external cooling. Thus, the inventors' designs improve the performance (quantified in terms of minimizing coolant usage and maintaining an isothermal part) of transpiring hardware.

The inventors found that improvements to cooling performance were not simply based on experiments of the component subjected to aerodynamic, thermal, and dynamic environments generally applicable to a variety of vehicle configurations. Rather, the inventors created a better component (i.e., aircraft nose) design in which the local mass flux is tailored by tailoring the component properties (geometry and composition). This is unexpected because if one were to attempt to cool a part via transpiration to maintain an isothermal part without the above-noted unexpected discovery, one would locally tailor the coolant flow rate to balance local incident heat flux, i.e., V~Q. As such, the inventors' improved designs can be characterized, unexpectedly, based on the geometry and composition of the component with respect to sweep angle. The inventors' new designs minimize mass flow rate, which minimizes the burden of thermal management, while maintaining vehicle (e.g., aircraft) hardware at a more uniform temperature, alleviating thermomechanical stress.

Values for the parameter (c) evaluated with the corresponding to the examples and embodiments in Table 1 are provided below in Table 2.

TABLE 2

| c | K₀ | K | t₀ | t | L |
|---|---|---|---|---|---|
| — | μm² | μm² | mm | mm | degrees |
| 0.4 | 1 | 1 | 1 | 1 | 0 |
| 0.4 | 1 | 1 | 1 | 1.006171 | 10 |
| 0.4 | 1 | 1 | 1 | 1.06188 | 30 |
| 0.4 | 1 | 1 | 1 | 1.122163 | 40 |
| 0.4 | 1 | 1 | 1 | 1.4 | 60 |
| 0.4 | 1 | 1 | 1 | 1.769522 | 70 |
| 0.4 | 1 | 1 | 1 | 1 | 0 |
| 0.4 | 1 | 0.993867 | 1 | 1 | 10 |
| 0.4 | 1 | 0.941726 | 1 | 1 | 30 |
| 0.4 | 1 | 0.818137 | 1 | 1 | 50 |
| 0.4 | 1 | 0.565124 | 1 | 1 | 70 |
| 4 | 1 | 1 | 1 | 1 | 0 |
| 4 | 1 | 1 | 1 | 1.061706 | 10 |
| 4 | 1 | 1 | 1 | 1.618802 | 30 |
| 4 | 1 | 1 | 1 | 3.222895 | 50 |
| 4 | 1 | 1 | 1 | 8.695218 | 70 |
| 4 | 1 | 1 | 1 | 1 | 0 |
| 4 | 1 | 0.94188 | 1 | 1 | 10 |
| 4 | 1 | 0.617741 | 1 | 1 | 30 |
| 4 | 1 | 0.31028 | 1 | 1 | 50 |
| 4 | 1 | 0.115006 | 1 | 1 | 70 |

The concise selection of the composition and geometry of the nose section 14 through use of the disclosed expression has been found to result in a nose section 14 that has a uniform cooling. In other words, the nose section 14 has a uniform temperature during operation. Put another way, a thermal gradient is not experienced across the nose section 14 during cooling. The conventional vehicle would still experience this thermal gradient across the nose section as some portions of the nose section are cooled more than other sections due to the even distribution of the cooling fluid. The elimination of the thermal gradient in the nose section 14, as described herein, in turn, reduces or otherwise eliminates a thermal gradient experienced across the nose section 14, which ultimately results in lower thermal stresses across the nose section 14 when compared to the conventional vehicle.

The inventors further determined that the concise selection of the geometry and composition of the nose section 14 using the disclosed expressions above can be used to ensure optimal cooling for the nose section 14 for supersonic vehicle and more specifically hypersonic vehicle. As detailed herein, the faster that a vehicle goes, the higher the heating along the nose section 14 and therefore the higher amount of cooling needed to effectively shield against the heating. The expressions described herein can be used to design a nose section 14 for the vehicle 10 at all suitable speeds including supersonic and hypersonic vehicles. In other words, the expressions described herein can be used to ensure that the nose section 14 of a supersonic or hypersonic vehicle will not be overly heated during operation of the supersonic or hypersonic vehicle. As detailed herein, the cooling of the nose section 14 of the hypersonic vehicle is especially important when compared to the cooling of the nose section of the supersonic vehicle that travels at less than Mach 5 or a subsonic vehicle as the hypersonic vehicle will experience much higher heating along the nose section 14.

To the extent not already described, the different features and structures of the various embodiments can be used in combination, or in substitution with each other as desired. That one feature is not illustrated in all of the embodiments is not meant to be construed that it cannot be so illustrated but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Minimum and maximum values for thickness and permeability for corresponding values of the heat flux parameter (c) are shown in Table 3.

TABLE 3

| | c | K₀ | K_{local} | | t₀ | t_{local} | | L | |
|---|---|---|---|---|---|---|---|---|---|
| Min | 0.4 | 1 μm² | 0.115006 | μm² | 1 mm | 1 | mm | 0 | degrees |
| Max | 4 | 1 μm² | 1 | μm² | 1 mm | 8.695218 | mm | 70 | degrees |

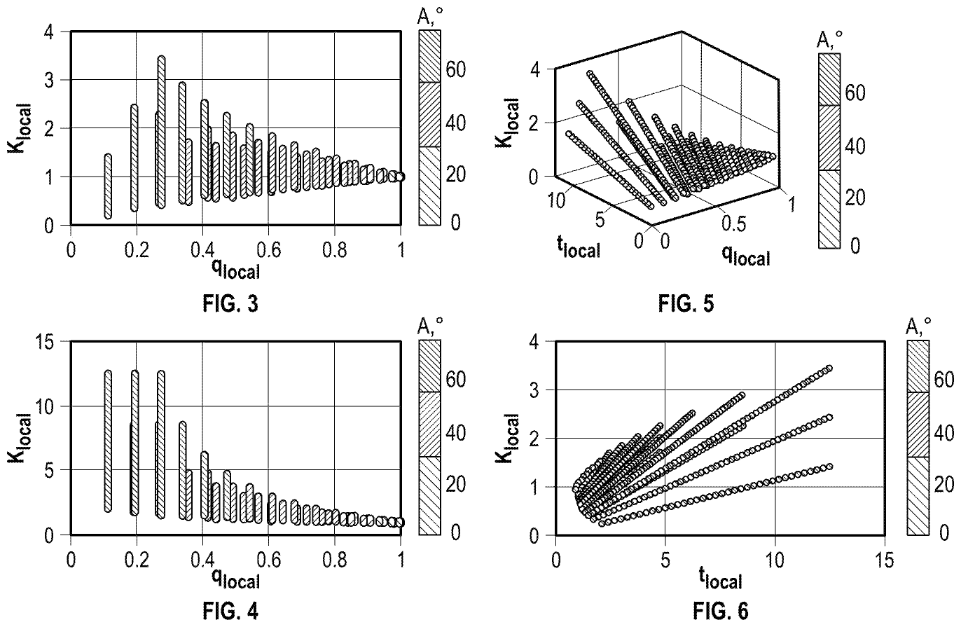

FIGS. 3 and 4 are graphs illustrating K_{local}/K₀ vs q_{local}/q₀ and t_{local}/to vs q_{local}/q₀, respectively. FIG. 5 is a graph illustrating K_{local}/K₀ vs q_{local}/q₀ vs t_{local}/t₀. FIG. 6 is a graph illustrating K_{local}/K₀ vs t_{local}/t₀. For the graphs in FIGS. 3-6:

$$\frac{{q}_{local}}{{q}_{0}} = \frac{( \frac{{k}_{local}}{{k}_{0}} )}{( \frac{{t}_{local}}{{t}_{0}} )} .$$

An example thirty-seven data points were used for t_{local}/t₀. For the above graphs in FIGS. 3-6, the following equation was evaluated: t_{local}/t₀=(sec(L)−1)*c+1, with c=[0.4,1:4.0]. K_{local}/K₀ was determined to satisfy expression (2).

The inventors' new designs minimize mass flow rate, which minimizes the burden of thermal management, while maintaining vehicle (e.g., aircraft) hardware at a more uniform temperature, alleviating thermomechanical stress. The set of inventive designs created by the inventors enable transpiration cooling at swept leading edges of the hypersonic vehicle using porous media with variable resistance, which is created by adjusting wall thickness and/or permeability of the material. The heat flux parameter (c) is a shorthand to represent inventive designs that provide locally-prescribed flow resistance that improves cooling while balancing durability and structural integrity.

Further aspects are provided by the subject matter of the following clauses:

A vehicle, comprising an outer wall defining a swept leading edge and a central axis, the outer wall including an inner surface and an outer surface, the outer wall including a porous material provided between the inner surface and the outer surface, the outer wall extending to a tip having a tip thickness(t₀) and a tip permeability (K₀), the outer wall including a local portion disposed aft of the tip, the local portion having a local thickness (t_{local}) and a local permeability (K_{local}), wherein (L) is a sweep angle defined by an intersection of the central axis and a straight line extending perpendicular from the inner surface of the outer wall at the local portion and wherein a combined permeability and thickness of the swept leading edge (c) is as follows:

$$0.4 \leq \frac{( {t}_{local} / {t}_{0} ) / ( {K}_{local} / {K}_{0} )}{sec ( L ) - 1} \geq 4. .$$

The vehicle of any preceding clause, wherein the outer wall includes a flared cross-section aft of the tip.

The vehicle of any preceding clause, wherein the permeability (K₀) is larger than the local permeability (K_{local}).

The vehicle of any preceding clause, wherein the outer wall includes a plurality of local permeabilities in the outer wall aft of the tip.

The vehicle of any preceding clause, wherein each local permeability of the plurality of local permeabilities is the same or different from one or more of the other local permeabilities of the plurality of local permeabilities.

The vehicle of any preceding clause, wherein the vehicle is a supersonic aircraft.

The vehicle of any preceding clause, wherein the tip is a leading edge of an engine or a leading edge of a component within the engine.

The vehicle of any preceding clause, wherein the outer wall defines a nose section of the vehicle.

The vehicle of any preceding clause, wherein the inner surface of the outer wall defines a nose interior disposed in fluid communication with a cooling circuit.

The vehicle of any preceding clause, wherein the cooling circuit is configured to exhaust a cooling fluid through the nose interior and the porous material of the outer wall to the outer surface of the outer wall.

A vehicle, comprising: a body extending between a tip and a tail section, the body defining a central axis extending through the tip and the tail section, the body defining a swept leading edge and including an inner surface and an outer surface, the body including a porous material provided between the inner surface and the outer surface, the tip having a tip thickness (t₀) and a tip permeability (K₀), the body including a local portion disposed aft of the tip, the local portion having a local thickness (t_{local}) and a local permeability (K_{local}), wherein (L) is a sweep angle defined by an intersection of the central axis and a straight line extending perpendicular from the inner surface of the outer wall at the local portion and wherein a combined permeability and thickness of the swept leading edge (c) is as follows:

$$0.4 \leq \frac{( {t}_{local} / {t}_{0} ) / ( {K}_{local} / {K}_{0} )}{sec ( L ) - 1} \geq 4. .$$

The vehicle of any preceding clause, wherein the swept leading edge includes a flared cross-section aft of the tip.

The vehicle of any preceding clause, wherein the permeability (K₀) is larger than the local permeability (K_{local}).

The vehicle of any preceding clause, wherein the swept leading edge includes a plurality of local permeabilities that are equal to or non-equal to each other.

The vehicle of any preceding clause, wherein the vehicle is an aircraft.

The vehicle of any preceding clause, wherein the vehicle is a supersonic vehicle.

The vehicle of any preceding clause, wherein the vehicle is a hypersonic vehicle.

The vehicle of any preceding clause, wherein the swept leading edge is defined by a nose section, a portion of a wing, a fin-like control surface, and/or a vertical or horizontal stabilizer.

The vehicle of any preceding clause, wherein the body defines an interior cavity, and the vehicle further comprises a cooling circuit at least partially defined by the interior cavity and configured to exhaust cooling fluid through the porous material to the outer surface.

An aircraft defining a central axis, the aircraft comprising: a body extending between a nose portion and a tail section, the nose portion terminating at a tip and having a swept leading ledge, the swept leading edge including a porous material, the tip having a tip thickness(t₀) and a tip permeability (K₀), the nose portion including a local portion disposed aft of the tip, the local portion having a local thickness (t_{local}) and a local permeability (K_{local}), wherein (L) is a sweep angle defined by an intersection of the central axis and a straight line extending perpendicular from the inner surface of the outer wall at the local portion and wherein a combined permeability and thickness of the swept leading edge (c) is as follows:

$$0.4 \leq \frac{( {t}_{local} / {t}_{0} ) / ( {K}_{local} / {K}_{0} )}{sec ( L ) - 1} \geq 4. .$$

It should be understood that the description herein is only illustrative of this disclosure. Various alternatives and modifications can be devised by those skilled in the art without departing from the disclosure. Accordingly, this disclosure is intended to embrace all such alternatives, modifications, and variances. The aspects described are presented only to demonstrate certain examples of the disclosure. Other elements, steps, methods, and techniques that are insubstantially different from those described above and/or in the appended claims are also intended to be within the scope of the disclosure.

What is claimed is:

1. A vehicle comprising:
an outer wall defining a swept leading edge and a central axis, the outer wall including an inner surface and an outer surface, the outer wall including a porous material provided between the inner surface and the outer surface, the outer wall extending to a tip having a tip thickness(t₀) and a tip permeability (K₀), the outer wall including a local portion disposed aft of the tip, the local portion having a local thickness (t_{local}) and a local permeability (K_{local}),
wherein (L) is a sweep angle defined by an intersection of the central axis and a straight line extending perpendicular from the inner surface of the outer wall at the local portion and wherein a combined permeability and thickness of the swept leading edge is represented by a heat flux parameter (c) as follows:
$$0.4 \leq \frac{( {t}_{local} / {t}_{0} ) / ( {K}_{local} / {K}_{0} )}{sec ( L ) - 1} \geq 4. .$$

2. The vehicle of claim 1, wherein the outer wall includes a flared cross-section aft of the tip.

3. The vehicle of claim 1, wherein the permeability (K₀) is larger than the local permeability (K_{local}).

4. The vehicle of claim 1, wherein the outer wall includes a plurality of local permeabilities in the outer wall aft of the tip.

5. The vehicle of claim 4, wherein each local permeability of the plurality of local permeabilities is the same or different from one or more of the other local permeabilities of the plurality of local permeabilities.

6. The vehicle of claim 1, wherein the vehicle is a supersonic aircraft.

7. The vehicle of claim 1, wherein the tip is a leading edge of an engine or a leading edge of a component within the engine.

8. The vehicle of claim 1, wherein the outer wall defines a nose section of the vehicle.

9. The vehicle of claim 8, wherein the inner surface of the outer wall defines a nose interior disposed in fluid communication with a cooling circuit.

10. The vehicle of claim 9, wherein the cooling circuit is configured to exhaust a cooling fluid through the nose interior and the porous material of the outer wall to the outer surface of the outer wall.

11. A vehicle comprising:
a body extending between a tip and a tail section, the body defining a central axis extending through the tip and the tail section, the body defining a swept leading edge and including an inner surface and an outer surface, the body including a porous material provided between the inner surface and the outer surface, the tip having a tip thickness(t₀) and a tip permeability (K₀), the body including a local portion disposed aft of the tip, the local portion having a local thickness (t_{local}) and a local permeability (K_{local}),
wherein (L) is a sweep angle defined by an intersection of the central axis and a straight line extending perpendicular from the inner surface at the local portion and wherein a combined permeability and thickness of the swept leading edge is represented by a heat flux parameter (c) as follows:
$$0.4 \leq \frac{( {t}_{local} / {t}_{0} ) / ( {K}_{local} / {K}_{0} )}{sec ( L ) - 1} \geq 4. .$$

12. The vehicle of claim 11, wherein the swept leading edge includes a flared cross-section aft of the tip.

13. The vehicle of claim 11, wherein the permeability (K₀) is larger than the local permeability (K_{local}).

14. The vehicle of claim 11, wherein the swept leading edge includes a plurality of local permeabilities that are equal to or non-equal to each other.

15. The vehicle of claim 11, wherein the vehicle is an aircraft.

16. The vehicle of claim 11, wherein the vehicle is a supersonic vehicle.

17. The vehicle of claim 11, wherein the vehicle is a hypersonic vehicle.

18. The vehicle of claim 11, wherein the swept leading edge is defined by a nose section, a portion of a wing, a fin-like control surface, and/or a vertical or horizontal stabilizer.

19. The vehicle of claim 18, wherein the body defines an interior cavity, and the vehicle further comprises a cooling circuit at least partially defined by the interior cavity and configured to exhaust cooling fluid through the porous material to the outer surface.

20. An aircraft defining a central axis, the aircraft comprising:
a body extending between a nose portion and a tail section, the nose portion terminating at a tip and having a swept leading ledge, the swept leading edge including a porous material, the tip having a tip thickness(t₀) and a tip permeability (K₀), the nose portion including a local portion disposed aft of the tip, the local portion having a local thickness (t_{local}) and a local permeability (K_{local}),
wherein (L) is a sweep angle defined by an intersection of the central axis and a straight line extending perpendicular from an inner surface of the body at the local portion and wherein a combined permeability and thickness of the swept leading edge is represented by a heat flux parameter (c) as follows:
$$0.4 \leq \frac{( {t}_{local} / {t}_{0} ) / ( {K}_{local} / {K}_{0} )}{sec ( L ) - 1} \geq 4. .$$
